(19) United States
(12) Patent Application Publication
(10) Pub. No.: US 2010/0134601 A1
(43) Pub. Date: Jun. 3, 2010

(54) METHOD AND DEVICE FOR DETERMINING THE POSE OF VIDEO CAPTURE MEANS IN THE DIGITIZATION FRAME OF REFERENCE OF AT LEAST ONE THREE-DIMENSIONAL VIRTUAL OBJECT MODELLING AT LEAST ONE REAL OBJECT

(75) Inventors: Valentin Lefevre, Puteaux (FR); Marion Passama, Paris (FR)

Correspondence Address: BROWDY AND NEIMARK, P.L.L.C.;624 NINTH STREET, NW, SUITE 300, WASHINGTON, DC, 20001-5303, US

(73) Assignee: TOTAL IMMERSION, Suresnes (FR)

(21) Appl. No.: 12/063,307

(22) PCT Filed: Aug. 9, 2006
(86) PCT No.: PCT/FR06/01934

§ 371 Date: Aug. 24, 2009

(30) Foreign Application Priority Data
Aug. 9, 2005 (FR) 0552479

(51) Int. Cl. H04N 13/04; G06T 15/00

(52) U.S. Cl. 348/51; 345/419; 382/154; 348/E13.075

(57) ABSTRACT

The invention relates to a method for determining the arrangement of a video capturing means in the capture mark of at least one virtual object in three dimensions, said at least one virtual object being a modelling corresponding to at least one real object present in images of the video image flows. The inventive method is characterised in that it comprises the following steps: a video image flow is received from the video capturing means; the video image flow received and at least one virtual object flow are displayed; points of said at least one virtual object are paired up, in real-time, with corresponding points in the at least one real object present in images of the video image flows; and the arrangement of said video capturing means is determined according to the points of the at least one virtual object and the paired point thereof in the at least one real object present in the images of the video image flows.

The present invention concerns the determination of the pose of video capture means in a real environment and more particularly a method and a device for determining the pose of video capture means in the digitization frame of reference of at least one three-dimensional virtual object modeling at least one real object.

It finds a general application in the determination of the pose of a video camera with a view to the insertion of virtual objects into the video images captured by the video camera.

Enhanced reality consists in fact in inserting virtual objects into a video image coming from video capture means.

Once inserted into the video images, the virtual objects must be seen in relation to the real objects present in the video with the correct perspective, the correct positioning and with a correct size.

The insertion of virtual objects into a video is at present effected after the video has been captured. For example, the insertion is effected in static frames in the video. These operations of insertion of virtual objects into a video necessitate high development costs.

Furthermore, the insertion of virtual objects in images in real time, i.e. on reception of the captured video images, is effected in an approximate manner.

The invention solves at least one of the problems stated hereinabove.

Thus the invention consists in a method of determination of the pose of video capture means in the digitization frame of reference of at least one virtual object in three dimensions, said at least one virtual object being a modeling corresponding to at least one real object present in images from the stream of video images, characterized in that it comprises the following steps:
reception of a stream of video images from the video capture means;

display of the stream of video images received and said at least one virtual object;
matching in real time points of said at least one virtual object with corresponding points in said at least one real object present in images from the stream of video images;
determination of the pose of said video capture means as a function of the points of said at least one virtual object and their matched point in said at least one real object present in the images from the stream of video images.

The method according to the invention determines the pose of a video camera in the digitization frame of reference of the virtual object modeled in three dimensions in order subsequently to be in a position to insert virtual objects into the real environment quickly and accurately.

The modeling is effected by means of three-dimensional virtual objects.

The pose is determined on the basis of the matching of points of at least one virtual object and points of the video images, in particular from matching selected points on the virtual object and their equivalent in the video image.

It is to be noted that the determination of the pose of video capture means is associated with the pose of a virtual video camera supplying parameters of the rendering of the virtual objects in three dimensions that constitute the elements added into the stream of video images.

Accordingly, the determination of the pose of the video capture means also determines the pose of the virtual video camera associated with the video capture means in the digitization frame of reference of the virtual object corresponding to the real object present in the stream of video images.

According to one particular feature, the method further comprises a step of displaying said at least one virtual object in a manner superposed on the stream of video images received.

According to this feature, it is possible to visualize the virtual object in the video window in order to verify the quality of the pose of the video capture means that has been determined and incidentally that of the virtual video camera.

According to another particular feature, the display of the received stream of video images and said at least one virtual object is effected in two respective side by side display windows.

According to another particular feature, the matching is carried out manually.

According to another particular feature, points of said at least one virtual object are selected by means of an algorithm for extraction of a point in three dimensions from a selected point in a virtual object.

According to this feature, the user selecting a node of the three-dimensional meshing representing the virtual object, the extraction algorithm is able to determine the point in three dimensions in that meshing that is closest to the location selected by the user.

According to another particular feature, the modeling further comprises at least one virtual object with no correspondence with the real objects present in the images from the stream of video images received.

According to this feature, the modeling of the real environment can comprise objects that can complement the real environment.

According to a particular feature, the method further comprises a step of modification in real time of the point of view of said at least one virtual object.

According to this feature, this enables visualization of the virtual object from different points of view, thereby enabling the user to verify the validity of the points matched with each other.

The invention also consists in a computer program comprising instructions adapted to carry out each of the steps of the method described hereinabove.

In a correlated way, the invention also provides a device for determination of the pose of video capture means in the digitization frame of reference of at least one virtual object in three dimensions, said at least one virtual object being a modeling corresponding to at least one real object present in images from the stream of video images, characterized in that it comprises:
means for receiving a stream of video images from the video capture means;
means for displaying the stream of video images received and said at least one virtual object;

means for matching in real time points of said at least one virtual object with corresponding points in said at least one real object present in images from the stream of video images;
means for determining the pose of said video capture means as a function of the points of said at least one virtual object and their matched point in said at least one real object present in the images from the stream of video images.

This device has the same advantages as the determination method briefly described hereinabove.

Other advantages, objects and features of the present invention emerge from the following detailed description, given by way of nonlimiting example, with reference to the appended drawing, in which:

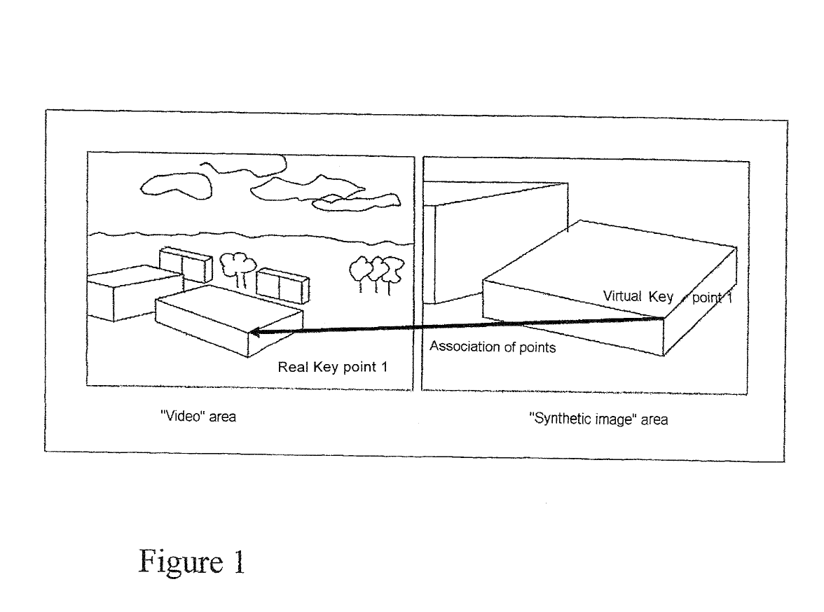

FIG. 1 illustrates diagrammatically the matching operation in accordance with the present invention.

The device and the method according to the invention determine the pose of video capture means in the digitization frame of reference of the virtual object modeling a real object present in the images from the stream of images in order to be able subsequently to insert virtual objects in real time quickly and accurately into the captured video.

It is to be noted that the pose is the position and the orientation of the video capture means.

It is to be noted that the determination of the pose of video capture means is associated with the pose of a virtual video camera in the view of the three-dimensional virtual objects modeling real objects present in images from the stream of video images.

Accordingly, the determination of the pose of the video capture means also determines the pose of the virtual video camera associated with the video capture means in the digitization frame of reference of the virtual object corresponding to the real object present in images from the stream of video images.

To this end, the device comprises video capture means, for example a video camera.

In a first embodiment, the video capture means consist of a video camera controlled robotically in pan/tilt/zoom, where appropriate placed on a tripod. It is a Sony EVI D100 or a Sony EVI D100P video camera, for example.

In a second embodiment, the video capture means consist of a fixed video camera.

In a third embodiment, the video capture means consist of a video camera associated with a movement sensor, the movement sensor determining in real time the position and the orientation of the video camera in the frame of reference of the movement sensor. The device also comprises personal computer (PC) type processing means, for example a laptop computer, for greater mobility.

The video capture means are connected to the processing means by two types of connection. The first connection is a video connection. It can be a composite video, S-Video, DV (Digital Video), SDI (Serial Digital Interface) or HD-SDI (High Definition Serial Digital Interface) connection.

The second connection is a connection to a communication port, for example a serial port, a USB port or any other communication port. This connection is optional. However, it enables the sending in real time of pan, tilt and zoom type parameters from the Sony EVI D100 type video camera to the computer, for example.

The processing means are equipped in particular with real time enhanced reality processing means, for example the D'FUSION software from the company TOTAL IMMERSION.

To implement the method of determining the pose of the video capture means in the digitization frame of reference of the virtual object modeled in three dimensions, the user takes the device described hereinabove into the real environment.

The user then chooses the location of the video camera according to the point of view that seems the most pertinent and installs the video camera, for example the pan/tilt/zoom camera, on a tripod.

There is described next the procedure for rapid determination of the pose of the virtual video camera in the modeling frame of reference of the virtual object modeled in three dimensions in accordance with the invention. This procedure obtains the pose of the video camera and of the associated virtual video camera for subsequent correct positioning of the virtual objects inserted into the video, i.e. the real scene and a perfect tracing out of the virtual objects. The parameters of the virtual video camera are used in fact during rendition, and those parameters produce in the end virtual objects that are perfectly integrated into the video image, in particular in position, in size and in perspective.

Once the localization software has been initialized, a window appears, containing, on the one hand, a real time video area, in which the images captured by video camera are displayed and, on the other hand, a “synthetic image” area, displaying one or more virtual objects in three dimensions, as shown in FIG. 1.

The “synthetic image” area contains at least the display of a virtual object the modeling whereof in three dimensions corresponds to a real object present in the stream of video images.

The synthetic images are traced out in real time, enabling the user to configure their point of view, in particular using a keyboard or mouse.

Thus the user can change the position and the orientation of their point of view.

The user can also change the field of view of their point of view.

These functions adjust the point of view of the synthetic image so that the synthesis window displays the virtual objects in a similar manner to the real objects corresponding to the video window.

The display of a real object from the video and of the virtual object at almost the same angle, from the same position and with the same field of view, accelerates and facilitates the matching of the points.

This modeling in three dimensions includes objects already present at the real location of the video camera.

However, the modeling can also contain future objects not present at the real location.

There follows, in particular by manual means, the matching of points in three dimensions selected on the virtual objects displayed in the synthetic image area and corresponding points in two dimensions in the stream of images from the real time video from the video area. Characteristic points are selected in particular.

In one embodiment, points of the real objects present in the images from the stream of images captured by the video camera are selected in the video window in order to determine a set of points in two dimensions. Each of those points is identified by means of an index.

In the same way, the equivalent points are selected in the synthetic image window, in particular according to a three-dimensional point extraction algorithm. To this end, the user selects a node of the three-dimensional meshing of a virtual object and the software determines the three-dimensional point closest to the location selected by the user. Each of these points is also identified by an index.

Being able to change the point of view of the synthetic image window in real time enables the user to verify if the extraction of points in the virtual object is correct.

Accordingly, as shown in FIG. 1, the key point 1 of the virtual object is matched with the key point 1 of the image of the video area.

This process must be as accurate and as fast as possible to enable precise and error-free determination of the pose of the video camera and incidentally of the virtual video camera associated with the video camera, for subsequent accurate insertion of virtual objects.

To this end, the device comprises the following functions.

The selection of points, in particular of key points in the images from the captured video, is described first.

In the embodiment in which the capture means consist of a robotic video camera, the movement of the video camera is controlled, in particular by means of a joystick, for example by the mouse. The movements of the video camera are guided by the pan and tilt functions controlled by the X and Y axis of the mouse, while the zoom is controlled in particular by the thumbwheel on the mouse.

In the embodiment in which the capture means consist of a robotic video camera, optical zooming onto the real key points is controlled to improve accuracy. The real key points can be selected within the zoomed image.

Once selected, a real key point continues to be displayed, and an index number is in particular associated with it and displayed in the video images even if the video camera moves in accordance with the pan/tilt/zoom functions.

The user can select a plurality of (N) key points in the video area, those points continuing to be displayed in real time with their index running from 1 to N. It is to be noted that these points are points whose coordinates are defined in two dimensions.

Secondly there is described the selection of points, in particular key points in the image present in the “synthetic image” area, that area containing virtual objects. It is to be noted that these points are points whose coordinates are defined in three dimensions.

Using the joystick or the mouse, for example, the user can move the point of view of the virtual video camera to obtain quickly a virtual point of view “close” to the point of view of the real video camera. The position and the orientation of the virtual video camera can be modified as in a standard modeling system.

Once the point of view has been fixed in the “synthesis” area, the user can select the N virtual key points, in particular by selecting the points with the mouse.

The virtual key points are displayed with their index, and they remain correctly positioned, even if the user changes the parameters of the virtual video camera.

Thanks to the algorithm for extracting a point in three dimensions (known as “picking”), each virtual key point selected, in particular with a peripheral for pointing in two dimensions, is localized by means of three coordinates (X, Y, Z) in the frame of reference of the synthetic image.

There follows the determination of the pose of the video camera as a function of the coordinates of the points in three dimensions selected on the virtual objects and the matched points in two dimensions in the stream of video images.

To this end, the software stores in memory the following information:
the plurality of real key points in two dimensions of the N matched real key points in the real image, together with their index between 1 and N;
the plurality of virtual key points in three dimensions of the virtual key points selected on the virtual objects, with for each virtual key point its coordinates (X, Y, Z) in the digitization frame of reference of the virtual objects and its index between 1 and N.

The pose of the video camera in the digitization frame of reference of the virtual objects is determined from this information. To this end, the POSIT algorithm is used to determine the pose of the video camera and of the virtual video camera associated with the video camera in the digitization frame of reference of the virtual objects corresponding to the real objects present in the images from the stream of received images.

For more ample information on these methods, the reader is referred in particular to the following reference: the paper entitled “Model-Based Object Pose in 25 Lines of Code”, by D. DeMenthon and L. S. Davis, published in “International Journal of Computer Vision”, 15, pp. 123-141, June 1995, which can be consulted in particular at the address http://www.cfar.umd.edu/˜daniel/.

In one embodiment, the virtual object of the virtual image that has been used for matching can be superposed on the real object present in the images from the stream of images used for matching, in particular to verify the quality of the determination of the pose. Other virtual objects can also enrich the video visualization.

To this end, a first step is to de-distortion the images from the video camera in real time.

The information as to the pose of the video camera or of the virtual video camera determined by means of the to method described hereinabove is then used.

On insertion of virtual objects into the video, this pose information is used to trace out the virtual objects correctly in the video stream, in particular, from the correct point of view, and therefore from a correct perspective, and to effect a correct pose of the objects relative to the real world.

Moreover, if necessary, the virtual objects are displayed in transparent mode in the stream of video images by means of transparency (“blending”) functions used in particular in the D'FUSION technology.

It is to be noted that the device according to the invention is easily transportable because it necessitates only a laptop computer and a video camera.

Furthermore, it can operate on models or on a one to one scale.

The device is also able to operate inside or outside buildings or vehicles.

The method and a device according to the invention also have the advantage, on the one hand, of being quick to install and, on the other hand, of determining quickly the pose of the video camera in the digitization frame of reference of the virtual object.

Moreover, it is not necessary to use a hardware sensor if the video camera is in a fixed plane. The matching of the points is effected without changing the orientation and position of the real video camera.

It is to be noted that the embodiment in which the capture means consist of a video camera having pan/tilt/zoom functions, the method and the device according to the invention can be used in buildings, in particular to work at a one to one scale in front of buildings or inside buildings. Most of the time, the user has only limited scope for moving back, and the real scene is therefore seen only partially by the video camera.

A non-exhaustive list of the intended applications is given next:
in the field of construction or building:
   on a site, for verification of the state of progress of the works, in particular by superposing the theoretical works (modeled by means of a set of virtual objects) on the real works filmed by the video camera.
   on a real miniature maquette illustrating the object to be achieved, for the addition of virtual objects.
   for the laying out of factories, it is permitted to display works not yet carried out in an existing factory, to test the viability of the project.
in the automotive domain:
   for locking a virtual cockpit onto a real cockpit.
   for locking a virtual vehicle into a real environment, for example to produce a showroom.

1. Method of determination of the pose of video capture means in the digitization frame of reference of at least one virtual object in three dimensions, said at least one virtual object being a modeling corresponding to at least one real object present in images from the stream of video images, characterized in that it comprises the following steps:
reception of a stream of video images from the video capture means;
display of the stream of video images received and said at least one virtual object;
matching in real time points of said at least one virtual object with corresponding points in said at least one real object present in images from the stream of video images;
determination of the pose of said video capture means as a function of the points of said at least one virtual object and their matched point in said at least one real object present in the images from the stream of video images.

2. Determination method according to claim 1, characterized in that the method further comprises a step of displaying said at least one virtual object in a manner superposed on the stream of video images received.

3. Determination method according to claim 1, characterized in that the display of the received stream of video images and said at least one virtual object is effected in two respective side by side display windows.

4. Determination method according to claim 1, characterized in that the matching is carried out manually.

5. Determination method according to claim 1, characterized in that points of said at least one virtual object are selected by means of an algorithm for extraction of a point in three dimensions from a selected point in a virtual object.

6. Determination method according to claim 1, characterized in that the modeling further comprises at least one virtual object with no correspondence with the real objects present in the images from the stream of video images received.

7. Determination method according to claim 1, characterized in that the method further comprises a step of modification in real time of the point of view of said at least one virtual object.

8. Computer program comprising instructions adapted to carry out each of the steps of the method according to claim 1.

9. Device for determination of the pose of video capture means in the digitization frame of reference of at least one virtual object in three dimensions, said at least one virtual object being a modeling corresponding to at least one real object present in images from the stream of video images, characterized in that it comprises the following steps:
means for receiving a stream of video images from the video capture means;
means for displaying the stream of video images received and said at least one virtual object;
means for matching in real time points of said at least one virtual object with corresponding points in said at least one real object present in images from the stream of video images;
means for determining the pose of said video capture means as a function of the points of said at least one virtual object and their matched point in said at least one real object present in the images from the stream of video images.

10. Determination device according to claim 9, characterized in that the device further comprises means for displaying said at least one virtual object in a manner superposed on the stream of video images received.

11. Determination device according to claim 9, characterized in that the display means are adapted to display the received stream of video images and said at least one virtual object in two respective side by side display windows.

12. Determination device according to claim 9, characterized in that the device includes means for controlling matching manually.

13. Determination device according to claim 9, characterized in that points of said at least one virtual object are selected by means of an algorithm for extraction of a point in three dimensions from a point selected in a virtual object.

14. Determination device according to, claim 9, characterized in that the modeling further comprises at least one virtual object with no correspondence with the real objects present in the images from the stream of video images received.

15. Determination device according to claim 9, characterized in that the device further comprises means for modification in real time of the point of view of said at least one virtual object.
